(19) United States
(12) Patent Application Publication
(10) Pub. No.: US 2026/0088974 A1
(43) Pub. Date: Mar. 26, 2026

(54) ENCRYPTED COMMUNICATIONS USING A SHORT PULSE WIDTH MODULATION (PWM) CODE (SPC) PROTOCOL

(71) Applicant: Infineon Technologies AG, Neubiberg (DE)

(72) Inventors: Jakob Valtl, Muenchen (DE); Konrad Kapser, Graefelfing (DE); Joao Cunha, Muenchen (DE); Florian Mendel, Muenchen (DE); Alexander Zeh, Muenchen (DE); Christian Kegler, Grasbrunn (DE)

(21) Appl. No.: 18/895,660

(22) Filed: Sep. 25, 2024

(51) Int. Cl. H04L 9/08

(52) U.S. Cl. CPC H04L 9/0819; H04L 9/0869

(57) ABSTRACT

The described techniques address issues related to conventional SPC protocols, and provides AEAD without any additional overhead in the data transfer during normal operation. An additional encryption seed transfer stage is implemented as part of the initial setup mode between the primary device and each other secondary device (e.g. sensors) for which secured SPC communications are to be performed. The secondary devices may thereafter transmit encrypted sensor data, for example, using a variety of encryption techniques, which include sponge-based algorithms.

### TECHNICAL FIELD

The disclosure generally relates to the use of encrypted data communications and, more particularly, to the use of encrypted data communications in accordance with a short pulse width modulation (PWM) code (SPC) protocol.

### BACKGROUND

Sensors are implemented in a variety of applications that require secure communications. This may include the use of sensors in applications such as real-time control systems that form part of in-vehicle networks. Thus, due to the critical nature of the systems in which sensors may be implemented, the data communicated between the sensors and other components of the system needs to be secured to prevent malicious attacks that could potentially pose significant safety risks. Such secure communications often includes the use of Authenticated encryption with associated data (AEAD). However, conventional SPC protocols, which are commonly used to support such sensor communications, do not support secure AEAD communications. Furthermore, although alternative secure communications have been proposed for sensor-based implementations, these suffer from drawbacks related to high latency and a weakness to replay attacks. As a result, conventional solutions to support secure sensor communications have been inadequate.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1 illustrates a conventional encryption process used for single edge nibble transmission (SENT) protocol;

FIG. 2 illustrates an example communication system implementing secured communications, in accordance with one or more embodiments of the disclosure;

FIG. 3A illustrates an SPC communication protocol timing diagram used for sensor communications and an accompanying conventional process flow that indicates the stages between power up and operation;

FIG. 3B illustrates a process flow for communications using a secured SPC communication protocol, which indicates the stages between power up and operation, in accordance with one or more embodiments of the disclosure;

FIG. 4 illustrates additional detail with respect to the example communication system implementing as shown in FIG. 2, in accordance with one or more embodiments of the disclosure;

FIG. 5 illustrates an example of the encryption process implemented by a device, in accordance with one or more embodiments of the disclosure;

FIG. 6 illustrates an example of an alternate primary device seed, in accordance with one or more embodiments of the disclosure;

FIG. 7A illustrates a sponge-based encryption operation, in accordance with one or more embodiments of the disclosure;

FIG. 7B illustrates a sponge-based decryption operation, in accordance with one or more embodiments of the disclosure; and

FIG. 8 illustrates the robustness of a sponge-based encryption operation to forgery attacks, in accordance with one or more embodiments of the disclosure.

The example aspects of the present disclosure will be described with reference to the accompanying drawings. The drawing in which an element first appears is typically indicated by the leftmost digit(s) in the corresponding reference number.

### SUMMARY

As discussed in further detail herein, SPC protocols communication are commonly used to support communications between different devices. This may include communications between one or more sensors and a microcontroller, an electronic control unit (ECU), etc., depending upon the particular application. The SPC communication protocol is a known protocol that includes enhanced interface features based on the Single Edge Nibble Transmission (SENT) protocol. The SENT protocol is defined by the Society of Automotive Engineers (SAE) J2716 specification at the time of this writing. For example, the SPC communication protocol introduces a Master Trigger Pulse (MTP) into the SENT frame definition, which acts as an address and assigns a unique time-encoded length to each sensor in terms of a multiple of a pre-programmed unit time (UT) value. This allows a single primary device (e.g. a microcontroller) to manage multiple secondary devices (e.g. sensors) on the same wired interface, which can reduce costs compared to the original one-to-one SENT specification.

However, although the SPC communication protocol enables additional features compared to the SENT protocol, the SPC communication protocol has not to date addressed secured sensor communications, as typical SPC communications are performed in the clear and do not utilize secured communication schemes. Such secured communication schemes commonly include, for instance, the use of sensor data authentication or, alternatively, authentication and encryption/decryption of sensor data. As one example, the proposed “UN Cyber Security for all cars” regulation requires encryption/authentication, and the currently-proposed solutions have various drawbacks and cannot fulfill all requirements of this proposal.

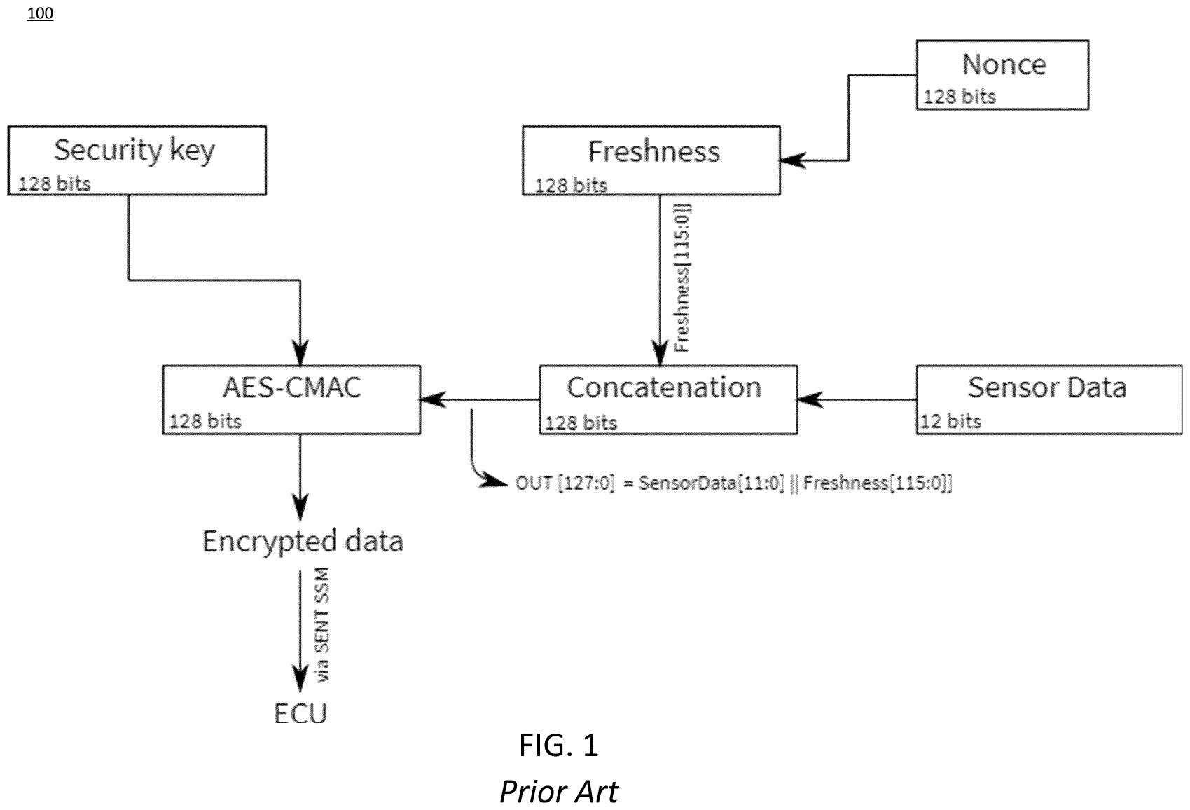

Additionally, alternative communications that rely upon the SENT protocol have been proposed that implement fingerprint communications to realize secured communications of sensor data. For instance, and as shown in FIG. 1, after a start-up stage, a freshness value such as a number used only once (nonce) is implemented as a random 128 bit value, and is transmitted via the SENT protocol using ID8-ID15. This requires 288 SENT frames (ID0 to ID15 to be transmitted, in one sequence), and the freshness value is incremented by 1 for each sequence.

The sensor data typically includes a hash consisting of different sensor values (e.g. a 12 bit torque value, a 16 bit torque value, a 2×12 bit angle value, etc.) depending on the sensor configuration, with the sensor data as shown in FIG. 1 representing a 12 bit value. Thus, all sensor values from ID0 to ID15 are used for a hash calculation, and the hash is concatenated with the freshness value of 116 bits to provide the concatenated output of 128 bits as shown. The MAC is then calculated using the 128 bit private key and the 128 bit output of the concatenated value, which yields a 128 bit MAC value that is transmitted with the SSM with ID8 to ID15.

However, the need to transmit the 288 SENT frames requires significant time, which leads to a latency problem and is thus ill-suited for many applications. Additionally, such solutions are not safe against replay attacks. For instance, an attacker may intercept a communication from the start, capture an intended secured message that is generated after the 288 SENT frames are transmitted, and then replay the captured values.

The embodiments discussed herein address these issues by enhancing the established SPC communication protocol with AEAD or, alternatively, authentication only, without any additional overhead in the data transfer during normal operation. To do so, and as discussed in further detail in Section I below, an additional encryption seed transfer stage is implemented as part of the initial setup mode between the primary device (e.g. a microcontroller) and each other secondary device (e.g. sensors) for which secured SPC communications are to be performed. The embodiments as described in further detail in Section I may utilize this encrypted setup mode to facilitate subsequent secured SPC communications. The encrypted setup mode may be performed by executing a series of operations to generate a common seed that is stored at the primary device and each secondary device without transmitting the common seed in the clear between devices, as this would present a security issue. This common seed may then be used to subsequently perform secured communication between devices, which may include AEAD communications as well as authentication only communications.

The encrypted setup mode may include the transmission of encrypted primary device seed data to each secondary device with which secured SPC communications are to be performed, which is generated by the primary device. This encrypted device seed data may comprise the entirety of the encrypted primary device seed. However, to reduce the time and bandwidth required to transmit the primary device seed, the embodiments described in Section II are directed to a seed optimization process. This process reduces the size of the encrypted device seed data by including only a portion of the primary device seed that is encrypted instead of the entire encrypted device seed. These embodiments exploit data that is available to the primary and secondary devices to enable each device to reconstruct the entire primary device seed by decrypting the encrypted portion of the primary device seed and then combining the decrypted portion of the primary device seed with locally stored data.

Furthermore, to enhance security measures, the primary and secondary devices may maintain a synchronized session counter that is stored in a memory of each device. The session counter may be incremented by the primary device after a threshold number of communication frames have been received, and also be incremented by each secondary device after a threshold number of communication frames are transmitted, which may occur in accordance with a predetermined scheme. The value of the session counter may be used by each secondary device to derive the primary device seed by combining the session counter value with the decrypted portion of the primary device seed, as noted above. The primary device seed is in turn used to generate the common seed for encryption/decryption/authentication.

However, in the event that the session counters become unsynchronized, the common seed value used by the primary and secondary devices will not match, resulting in synchronization errors such as a number of cyclic redundancy check (CRC) failures. Thus, to provide robust communications, Section III is directed to the use of a seed re-synchronization process. This includes the use of a reseeding counter, which is also stored by the primary and secondary devices. The reseeding counter may be used by each secondary device to derive the primary device seed by combining the reseeding counter value with the decrypted portion of the primary device seed, as noted above. The reseeding counter, when incremented, may result in the session counter being reset by the primary device to a predetermined value. Doing so re-synchronizes the common seed stored in the primary and secondary devices without re-executing the encrypted setup mode or the need to re-transmit the primary device seed.

Finally, Section IV is directed to an alternative sponge-based encryption process that implements the common seed as part of a cryptographic sponge function. Each secondary device may thus generate a data encryption key by providing the common seed and a pre-shared key that is stored by the primary and secondary devices as inputs to the cryptographic sponge function. The sponge-based encryption process provides the flexibility to encrypt only a portion of the generated sensor data (e.g. a CRC value) using the encryption key and an internal state of the cryptographic sponge function. The use of the sponge-based encryption process allows for another portion of sensor data to be transmitted as plaintext sensor data in addition to the encrypted portion, which may be particularly useful to facilitate an authentication only scheme.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

Again, the embodiments herein are presented in four separate Sections for ease of explanation. Section I is directed to the use of an encrypted seed generation and transfer process to facilitate encrypted communications between devices using a pulse-width modulation (PWM) code protocol, such as an SPC communication protocol for example. Section II is directed to a seed optimization process that reduces the size of the primary device seed that is transmitted as part of the initial encryption setup process. Section III is directed to a seed re-synchronization process that obviates the need to re-transmit the primary device seed that was transferred as part of the initial encrypted setup mode in the event that the common seed stored at each communicating device becomes unsynchronized. Section IV is directed to an alternative sponge-based encryption process.

Although the embodiments are discussed separately in each Section, it is noted that any of the embodiments described in any of the Sections may be combined with one another, and any of the architecture, processes, types of communications, encryption processes, algorithms, statements, etc., used to describe the use of secured communication between different devices described in any of the Sections are also applicable to the embodiments described in any of the other Sections. For example, any of the embodiments as described herein with respect to the seed optimization processes of Section II, the seed re-synchronization processes of Section III, and/or the sponge-based encryption processes of Section IV may optionally be implemented as any suitable part of secured communications described in Section I, as further discussed below.

Additionally, the various embodiments are discussed herein with respect to the use and/or modification of the SPC communication protocol. However, although the embodiments as discussed herein may be implemented in accordance with SPC protocols, the embodiments as discussed herein are not limited to a specific type or definition of a specific type of communication protocol. The embodiments as discussed herein may be implemented in accordance with any suitable type of communication protocol, such as those that utilize PWM-based encoding for communications. Such protocols may be referred to herein as PWM code protocols, and may implement the measurement of time lengths that are varied between one or more edges of a transmitted signal to encode data values based upon a correlation of predetermined time durations to predetermined data values. Such PWM code protocols may encompass the SENT protocol and SPC protocol as of the time of this writing, but may additionally or alternatively encompass any other suitable communication protocols that implement PWM-based encoding that may deviate in one or more ways from the SENT and the SPC protocols as of the time of this writing.

### Section I: Secured SPC Communications

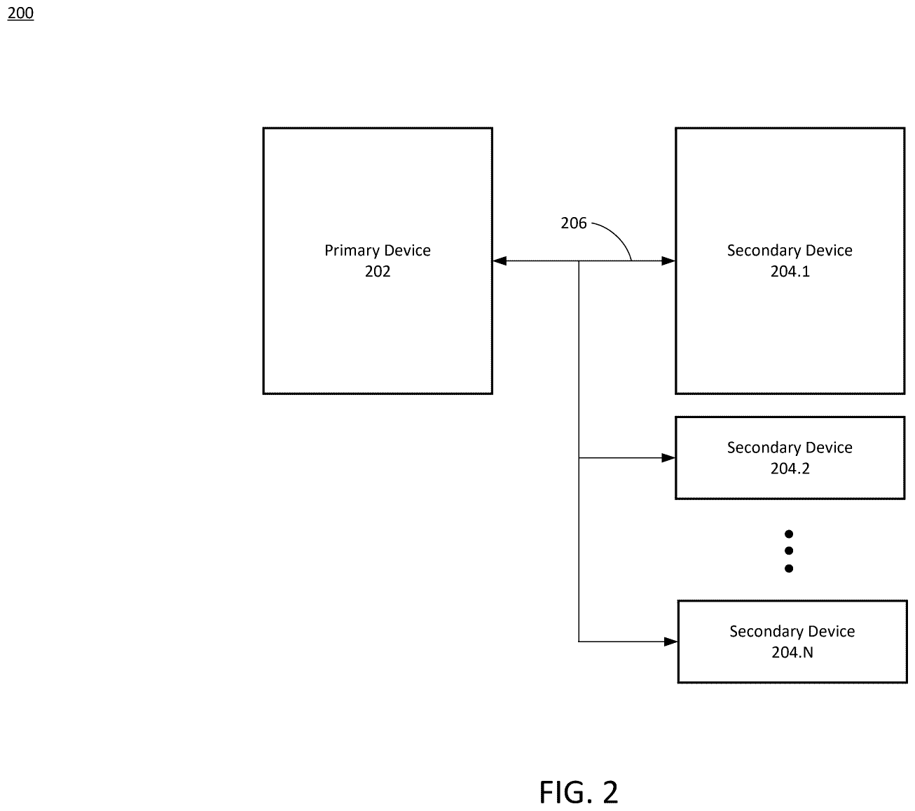

FIG. 2 illustrates an example communication system implementing secured communications, in accordance with one or more embodiments of the disclosure. The communication system 200 as shown in FIG. 2 includes a primary device 202 and any suitable number N of secondary devices 204.1-204.N. The primary device 202 and the secondary devices 204.1-204.N may be communicatively coupled to one another via the communication links 206, which may represent any suitable number and/or type of communication links that may facilitate the transfer of data in accordance with any suitable number and/or type of communication protocols. For instance, the communication links 206 may comprise wired and/or wireless links, buses, wires, cables, conductive traces, optical connections, etc.

The primary device 202 may be implemented as any suitable type of device, which may perform bidirectional and/or unidirectional communications with each of the secondary devices 204.1-204.N in accordance with any suitable number and/or type of communication protocols. For example, the primary device 202 may be implemented as a microcontroller, a host device, an electronic control unit (ECU), etc. The secondary devices 204.1-204.N may likewise be implemented as any suitable type of device, which may perform bidirectional and/or unidirectional communications with the primary devices 202 in accordance with any suitable number and/or type of communication protocols. For example, the secondary devices 204.1-204.N may be implemented as any suitable type of sensors, each being configured to generate sensor data in accordance with respective measurements of physical values such a magnitude and/or direction of a magnetic field, an applied force, a measured angle or measured torque of a rotatable shaft, a temperature, a liquid level measurement, humidity, etc.

Again, the primary device 202 and each of the secondary devices 204.1-204.N may communicate with one another via the communication links 206 using any suitable number and/or type of communication protocols. Such communication protocols may include, for instance, SPC communication protocols, which may include the various enhancements as discussed with respect to Sections I-IV to enable secured communications. Thus, the communication links 206 may comprise wires implemented in accordance with SPC protocols, such as a GND, VDD, and DATA wires. Additionally or alternatively, when communicating via an SPC communication protocol, the primary device 202 and each of the secondary devices 204.1-204.N may communicate with one another via a synchronous mode of operation (e.g. when only one secondary device 204.1-204.N is present) or via a bus mode of operation (e.g. when more than one secondary device 204.1-204.N is present).

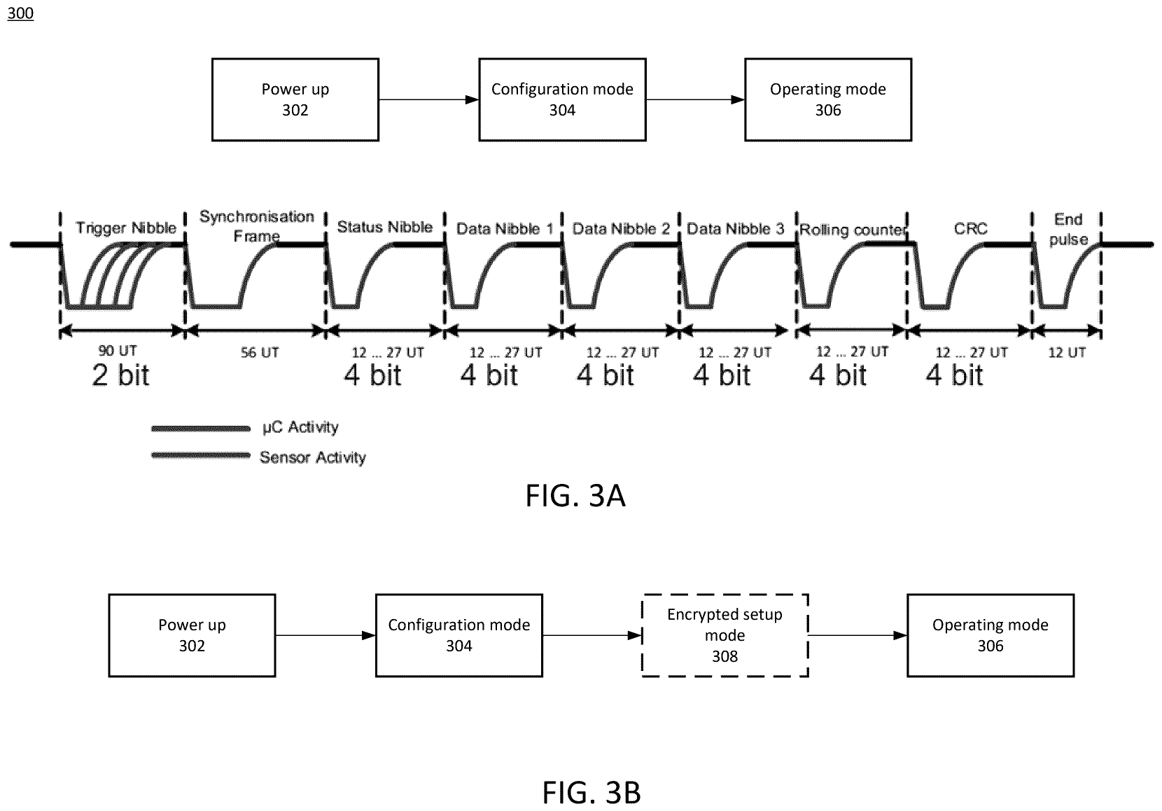

In any event, and turning now to FIGS. 3A and 3B, when an SPC communication protocol is implemented, this may include the use of data transmitted as a series of data bit groups, each including a time-encoded value representing any suitable number of bits. For instance, the time between two consecutive falling edges may define the value of an N-bit nibble. When N is 4, the data bit group may thus represent a data nibble that encodes a number between 0 and 15. The transmission time of each data bit group therefore depends on the transmitted data values. All values are multiples of a unit time frame, which is known by the primary device 202 and the secondary devices 204.1-204.N via the use of the synchronization frame transmission, as is generally known. Although the term “nibble” is used herein to define a four-bit data group, this is by way of example and not limitation. As is the case for the SENT and SPC communication protocols, the embodiments described herein may likewise implement data bit groups that are less than four bits in place of the four-bit data nibbles, such as e.g. 3 bits or less or, alternatively, more than four data bits per data bit group, in various embodiments.

An SPC frame typically includes a master trigger pulse (e.g. a trigger nibble) transmitted by the primary device 202, which initiates a data transmission by any of the connected secondary devices 204.1-204.N. Because several secondary devices 204.1-204.N may share the same bus, the trigger pulse (e.g. a trigger nibble) may encode one of several different possible values based upon its length. The trigger pulse is measured by each secondary device 204.1-204.N that receives the SPC frame to determine whether that particular secondary device 204.1-204.N has been requested to transmit data (e.g. measured sensor data). This feature is an enhancement from the SENT protocol as discussed above, as this allows a form of communication from the primary device 202 to the secondary devices 204.1-204.N that is not implemented in the unidirectional SENT protocol, which in contrast only allows the primary device 202 to receive data from the secondary devices 204.1-204.N.

Additionally, an SPC frame includes a synchronization frame having a length of 56 UT, and a status data bit group (e.g. status nibble) of a duration between 12-27 UT, which typically encodes over voltage/error signaling and short serial message (SSM) data or the sensor ID. The SPC frame also includes (in this example) 3 data bit groups (e.g. data nibbles) of a duration between 12-27 UT each (the number is programmable), which may represent sensor data, as well as one (in this example) 4-bit rolling counter of a duration between 12-27 UT (programmable). Finally, the SPC frame includes one (in this example) (CRC) data bit group (e.g. a CRC nibble) of a duration between 12-27 UT (programmable), as well as an end pulse of a duration of 12 UT to terminate the SPC frame transmission. Thus, for the example shown in FIG. 3A, the SPC frame includes a total of 3 bytes of data (the status nibble, 3 data nibbles, the rolling counter nibble, and the CRC nibble). Of course, an SPC frame may include additional data nibbles or other optional nibbles as is generally known, with the SPC frame format as shown in FIG. 3A being used as an example herein for ease of explanation.

With continued reference to FIG. 3A, a conventional SPC communication process is established using three modes (also referred to as stages) of operation. The first mode includes the power up mode, during which time the primary device 202 and one of the secondary devices 204.1-204.N is initialized from a powered down or off state to an on state. Next, the primary device 202 enters a configuration mode 304, during which time the primary device 202 transmits data to each of the secondary devices 204.1-204.N to configure each of the secondary devices 204.1-204.N for operation during the operating mode 306.

The configuration mode 304 may thus represent any suitable type of communications from the primary device 202 that instructs the secondary devices 204.1-204.N with respect to any suitable type of configuration data, such as calibration, measurement frequency, the number of bits to use to encode measured sensor data, a frequency of transmission, etc. Additionally or alternatively, the configuration mode 304 may include instructions to configure a non-volatile memory (e.g. an electrically erasable programmable read only memory (EEPROM)) of each of the secondary devices 204.1-204.N, which may then be locked entirely or partly, with no unlock option after configuration. The configuration mode 304 may comprise, for instance, a Single-wire Interface for Calibration and Inspection (SICI) mode of operation, which may use a pulse width modulation (PWM) encoding scheme, as is generally known.

The embodiments discussed in further detail herein enable such SPC communications to be performed as secured communications between the primary device 202 and the secondary devices 204.1-204.N. Such secured SPC communications may include, for instance, the transmission of data via any of the secondary devices 204.1-204.N that may be used as part of an authentication only scheme or an AEAD scheme. To do so, the SPC communications as shown in FIG. 3A may still be implemented, but the data bit groups (e.g. data nibbles) transmitted by the secondary devices 204.1-204.N may encode data that is to be authenticated by the primary device 202 or data that is encrypted and is to be decrypted and authenticated by the primary device 202 in accordance with any suitable authentication or authentication and encryption/decryption protocol. In each of these cases, and as further discussed below, such secured communications may utilize a common seed that is stored at the primary device 202 and each of the secondary devices 204.1-204.N for which secured communications is performed.

To enable secured communications using the SPC communication protocol, the embodiments described herein include the use of an additional encrypted setup mode 308, as shown in FIG. 3B. The encrypted setup mode 308 may occur after the configuration mode 304 has completed or a timeout period reserved for the configuration mode 304 has expired, for example. In any event, the encrypted setup mode 308 may be used to establish a common seed that may be used by the primary device 202 and the secondary devices 204.1-204.N during the subsequent operating mode 306 to perform secured communications in accordance with an SPC communication protocol, for example, as discussed in further detail below.

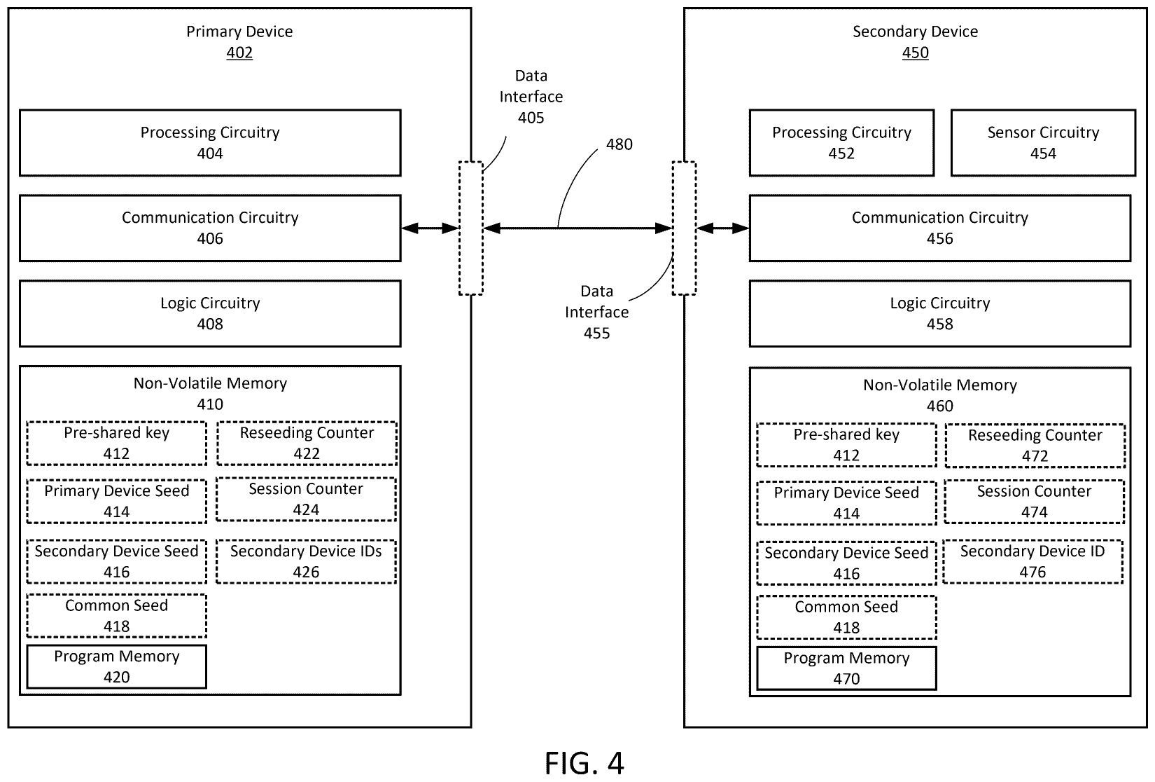

To do so, reference is now made to FIG. 4, which illustrates additional detail with respect to the example communication system 200 as shown in FIG. 2, in accordance with one or more embodiments of the disclosure. The primary device 402 may be identified with the primary device 202 as shown in FIG. 2, and the secondary device 450 may be identified with any one of the secondary devices 204.1-204.N as shown in FIG. 2. The communication links 480 may be identified with the communication links 206 as shown in FIG. 2. Thus, the primary device 402 and the secondary device 450 may communicate with one another as discussed in further detail herein via the communication links 480, which may include the use of a secured SPC communication protocol for instance. The encrypted setup mode 308 results in a common seed 418 that is stored in the non-volatile memory 410, 460 of each of the primary and secondary devices 402, 450 to enable the secured SPC communications between the primary and the secondary devices 402, 450 during the operating mode 306.

Thus, the primary device 402 may include processing circuitry 404, communication circuitry 406, logic circuitry 408, and a non-volatile memory 410. The secondary device 450 may likewise include processing circuitry 452, communication circuitry 456, logic circuitry 458, and a non-volatile memory 460, which may be configured to operate in a similar manner as the processing circuitry 404, communication circuitry 406, logic circuitry 408, and non-volatile memory 410, respectively, of the primary device 402, as further discussed below, excepting for other differences in their operation as discussed herein.

The secondary device 450 may additionally include sensor circuitry 454, which may include any suitable number and/or type of sensors and/or sensor elements. Thus, the sensor circuitry 454 may be configured to generate sensor data in accordance with any suitable physical measurement in accordance with the configuration and type of the secondary device 450. As discussed in further detail herein, the sensor data generated via the sensor circuitry 454 may be encrypted and transmitted as part of or the entirety of encrypted sensor data in accordance with the SPC protocol, which may include the use of any suitable encryption schemes to do so.

Each of the primary and secondary devices 402, 450 may include additional, fewer, or alternate components than those shown in FIG. 4, which are provided by way of example and not limitation. For instance, the primary and secondary devices 402, 450 may include other types of memory such as volatile memory, and any of the data stored in the non-volatile memories 410, 460 may alternatively or additionally be stored in such volatile memories. As yet another example, the primary and secondary devices 402, 450 may include hardware-dedicated components (e.g. hardware accelerators) that may perform any of the operations as discussed herein in addition to or instead of the processing circuitry 404 and/or the logic circuitry 408. Moreover, although shown as separate components, any of the components of the primary and secondary devices 402, 450 may be integrated or otherwise combined with one another.

The processing circuitry 404, 452 may comprise any suitable number and/or type of hardware components. For instance, the processing circuitry 404, 452 may be implemented as any suitable number and/or type of dedicated hardware components such as a microcontroller, an application specific integrated circuit (ASIC), a field programmable gate array (FPGA), a system on a chip (SoC), dedicated logic and/or other circuitry, a multi-processing unit (MPU), an application processing unit (APU), a hardware-based state machine, etc. The processing circuitry 404, 452 may be implemented as one or more processors and/or cores, which may execute computer-readable instructions stored in the respective program memories 420, 470 to perform any of the various functions as discussed in further detail herein. The processing circuitry 404, 452 and the program memories 420, 470 are illustrated in FIG. 4 as separate components. However, this is for ease of explanation, and it is understood that the processing circuitry 404, 452 and the program memories 420, 470, respectively, may, in some embodiments, comprise a single component.

The communication circuitries 406, 456 may be implemented as any suitable hardware components that enable communications between the primary and secondary devices 402, 450, as further discussed herein, via the data interfaces 405, 455 and the communication links 480. Thus, the communication circuitries 406, 456 may perform secured communications by transmitting and receiving secured data (e.g. secured SPC frames) in accordance with any suitable number and/or type of communication protocols, such as those discussed herein. To do so, the communication circuitries 406, 456 may comprise hardware components, software components, or combinations of these, which are typically associated with components configured to perform data communications.

For example, the communication circuitries 406, 456 may comprise any suitable number of ports, drivers, transmit and/or receive buffers, switches, etc. Additionally or alternatively, the communication circuitries 406, 456 may comprise any suitable number and/or type of dedicated hardware components such as a microcontroller, an application specific integrated circuit (ASIC), a field programmable gate array (FPGA), a system on a chip (SoC), dedicated logic and/or other circuitry, a multi-processing unit (MPU), an application processing unit (APU), a hardware-based state machine, etc. The communication circuitries 406, 456 may be implemented as one or more processors and/or cores, which may execute computer-readable instructions stored in the respective program memories 420, 470 to perform any of the various functions as discussed in further detail herein. The communication circuitries 406, 456 may be separate components or integrated as part of their respective processing circuitries 404, 452, in various embodiments.

Although referred to herein as “circuitry,” the processing circuitry 404, 452 and/or the communication circuitry 406, 456 may perform their respective operations as discussed herein using software, hardware, or combinations of these. For instance, any of the operations performed to implement the secured SPC communications as discussed herein may be performed via the processing circuitry 404, 452 and/or the communication circuitry 406, 456 executing instructions stored in their respective program memories 420, 470, as dedicated hardware components, or combinations of these.

The data interfaces 405, 455 may be configured to facilitate the transmission and/or reception of data in accordance with any suitable protocols. In an embodiment, each of the data interfaces 405, 455 may represent the physical layer and the accompanying data interfaces used in accordance with any suitable communication protocol and/or standard, such as SPC for example. Additionally or alternatively, the data interfaces 405, 455 may represent any suitable hardware that couples the primary and secondary devices 402, 450 to the communication links 480, such as terminals, pins, ports, etc.

The logic circuitry 408, 458 may be implemented as any suitable arrangement and configuration of dedicated hardware to perform encryption-based functions, which may include performing bit-shifting and/or predetermined logic operations, as further discussed herein. For example, the logic circuitry 408, 458 may be implemented as hardware accelerators, a set of logic gates, an ASIC, an FPGA, etc. Additionally or alternatively, the logic circuitry 408, 458 may be implemented as any of the components described above with respect to the processing circuitry 404, 452 and/or the communication circuitry 406, 456.

The program memories 410, 460 may comprise any suitable type of non-transitory computer readable medium such as non-volatile memory for instance, which may include an EEPROM for example. To enable secured SPC communications, each of the primary and secondary devices 402, 450 may store a pre-shared key 412, which may be identical to one another. The pre-shared key 412, which may alternatively be referred to herein as a pre-shared secret, may represent any suitable value, such as a bit string of any suitable predetermined length for instance. The pre-shared key 412 may be generated via the processing circuitries 404, 452 of each respective primary and secondary devices 402, 450 in accordance with any suitable type of cryptographic function. Alternatively, the pre-shared key 412 may be stored in the program memories 410, 460 of each respective primary and secondary devices 402, 450 as part of an initial configuration process, during manufacture, etc. The pre-shared key 412 is generally static in nature, and may typically remain unchanged over the operating lifetime of each of the primary and secondary devices 402, 450.

As the first step in the encrypted setup mode 308, the primary device 402 may generate and store the primary device seed 414, which may represent a bit string of any suitable length, such as 128 bits, 256 bits, etc. To do so, the processing circuitry 404 may generate the primary device seed 414 using any suitable cryptographic function, which may be implemented as a nonce value for example, and which may represent a random bit string for instance. The primary device seed 414 may thus represent a decrypted or plaintext version of the primary device seed 414. The processing circuitry 404 may then encrypt at least a portion of the primary device seed 414 using the pre-shared key 412 to generate encrypted primary device seed data. The processing circuitry 404 may encrypt at least a portion of the primary device seed 414 using in this manner using any suitable predetermined encryption function. To provide some examples, the processing circuitry 404 may encrypt a portion of or the entirety of the primary device seed 414 using the pre-shared key 412 using AES, ASCON, PRESENT, etc.

As discussed in further detail below, a portion or the entirety of the primary device seed 414 may be used to generate encrypted device seed data that is then transmitted to the secondary device 450. In the embodiments discussed in this Section, it is assumed that the primary device seed 414 is encrypted using the pre-shared key 412 such that the encrypted device seed data has a bit length equal to that of the pre-shared key 412 and represents the entirety of the encrypted primary device seed 414. However, and as discussed in further detail in Section II below, the processing circuitry 404 may alternatively encrypt only a portion of the primary device seed 414 using the pre-shared key 412. In accordance with such embodiments, this portion of the encrypted primary device seed 414 may be used as the encrypted device seed data that is transmitted to the secondary device 450.

In any event, the communication circuitry 406 may transmit the encrypted device seed data to the secondary device 450 via any suitable communication protocol, such as the SPC communication protocol, a PWM protocol, etc. The secondary device 450 then receives the encrypted device seed data via the communication circuitry 456. The processing circuitry 452 decrypts the encrypted device seed data to derive the primary device seed 414, which is then stored in the non-volatile memory 460 as shown in FIG. 4. Again, in the embodiments as discussed in this Section, the encrypted device seed data represents the entirety of the encrypted primary device seed 414, and thus the processing circuitry 452 may decrypt the encrypted device seed data to directly recover the primary device seed 414. However, in other embodiments, which are discussed in further detail in Section II below, the decrypted device seed data may be combined with other data that is known by the primary and the secondary devices 402, 450 to derive the primary device seed 414.

Next, the secondary device 450 may perform a similar process to share its secondary device seed with the primary device 402. For example, the processing circuitry 452 may generate and store the secondary device seed 416 in the non-volatile memory 460, which may represent a bit string of any suitable length, such as 128 bits, 256 bits, etc. To do so, the processing circuitry 452 may generate the secondary device seed 416 using any suitable cryptographic function, which may be implemented as a nonce value for example, and which may represent a random bit string for instance. The secondary device seed 416 may thus represent a decrypted or plaintext version of the secondary device seed 416. The processing circuitry 452 may then encrypt the secondary device seed 416 using the pre-shared key 412 in accordance with any suitable predetermined encryption function to generate encrypted secondary device seed data. Again, to provide some examples, the processing circuitry 452 may encrypt the secondary device seed 416 using the pre-shared key 412 using AES, ASCON, PRESENT, etc. When the secondary device 450 is implemented as a sensor, the secondary device seed 416 and accompanying encrypted secondary device seed may be alternatively referred to herein as a sensor seed and an encrypted sensor seed, respectively.

The secondary device 450 is configured to then transmit, via the communication circuitry 456, the encrypted secondary device seed to the primary device 402 in accordance with any suitable protocol, such as the SPC communication protocol, a PWM protocol, etc. The communication circuitry 406 thus receives the encrypted secondary device seed from the secondary device 450. The processing circuitry 404 decrypts the encrypted secondary device seed to derive the secondary device seed 416, which is then stored in the non-volatile memory 410 as shown in FIG. 4. The processing circuitry 404 may decrypt the secondary device seed in this manner using any suitable predetermined encryption function that utilizes the pre-shared key 412, which may be the same predetermined encryption function used by the secondary device 450 to encrypt the secondary device seed 416. Thus, the same predetermined encryption function and the same pre-shared key 412 may be used by the primary deice 402 and the secondary device 450 to perform symmetrical encryption and decryption of the primary and the secondary device seeds 414, 416.

At this point, the primary and secondary devices 402, 450 each stores the primary and the secondary device seeds 414, 416. Thus, each of the primary and secondary devices 402, 450 generates and stores the common seed 418 using any suitable combination of the primary and the secondary device seeds 414, 416. The primary and secondary devices 402, 450 may each combine the primary and the secondary device seeds 414, 416 in any suitable manner to derive the same common seed 418. For example, the logic circuitry 408, 458 may be configured to generate the common seed 418 based upon a combination of the primary and the secondary device seeds 414, 416, which may include the use of a predetermined logic function. This predetermined logic function may comprise, for example, an exclusive or (XOR) function or other suitable logic function, such that the common seed 418 represents a bitwise XOR operation between each corresponding bit position of the primary and the secondary device seeds 414, 416.

As a result, each of the primary and secondary devices 402, 450 now stores the same common seed 418, which may be used to provide secured SPC communications during the operating mode 306 as discussed in further detail below. For example, the secondary device 450 may now use the common seed 418 to encrypt the measured sensor data, which is then transmitted to the primary device 402 in accordance with the SPC protocol. The processing circuitry 404 may be configured to decrypt the encrypted sensor data received in this manner using the common seed 418 to obtain the sensor data.

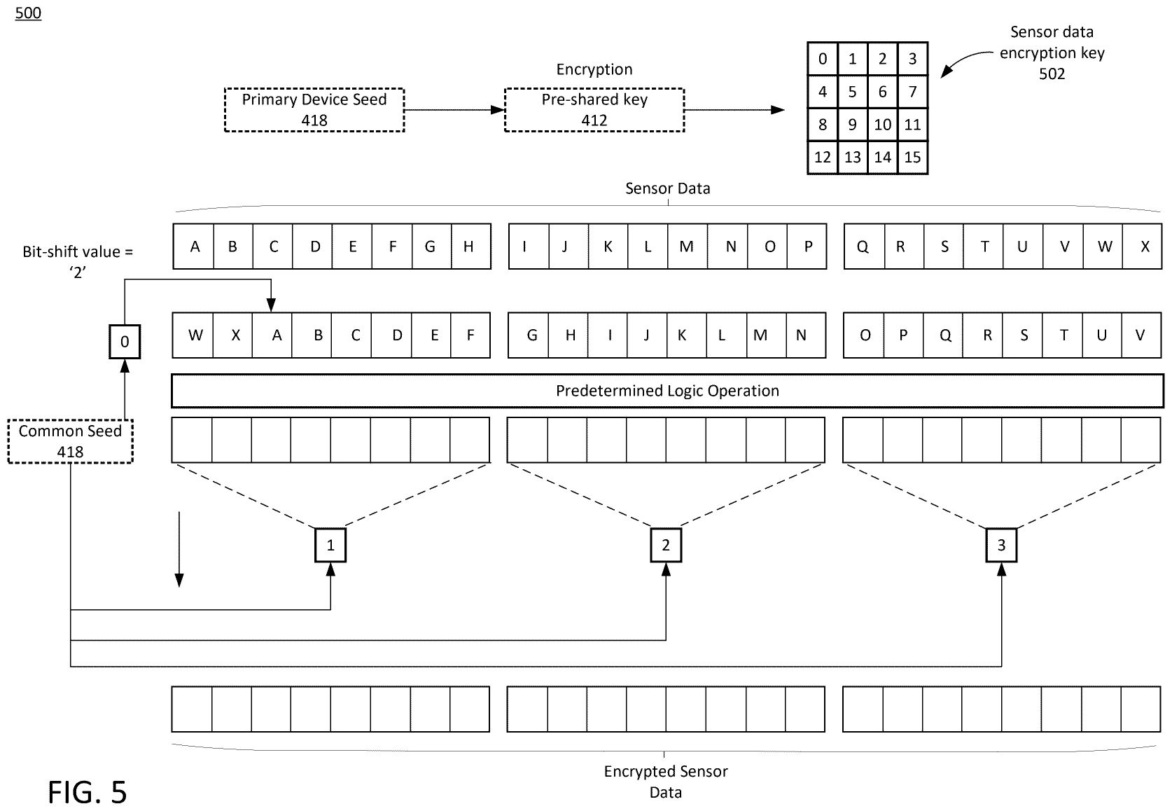

Thus, during the operating mode 306, the primary device 402 may transmit data to the secondary device 450 requesting sensor data. This may include, for example, the transmission of data in accordance with an SPC protocol, which may include a trigger pulse having a time-encoded duration that identifies an address or other identifier that is recognized by the secondary device 450 in accordance with known SPC protocol operations. In response, the secondary device 450 is configured to encrypt the measured sensor data using the common seed 418, which is then transmitted to the primary device 402. For example, the processing circuitry 452 may be configured to encrypt the sensor measurement data generated via the sensor circuitry 454, as well as any other suitable data that may be transmitted by the secondary device 450 as part of an SPC frame communication, using the common seed 418 to provide encrypted sensor data. The communication circuitry 456 may be configured to transmit the encrypted sensor data to the primary device 402 in accordance with the SPC protocol. This process is discussed in further detail below with respect to FIG. 5, which illustrates an example of the encryption process implemented by a device in accordance with one or more embodiments of the disclosure.

Again, the pre-shared key 412 may remain unchanged over the operating lifetime of the primary and secondary devices 402, 450, whereas the common seed 418 may be updated during ongoing communications. Thus, the common seed 418 may be alternatively referred to herein as a session key, which may be incremented or otherwise updated upon one or more predetermined conditions being satisfied with respect to the communications between the primary and the secondary devices 402, 450. Therefore, the common seed 418 generated by each of the primary and secondary devices 402, 450 after the completion of the encrypted setup mode 308 may serve as an initial common seed value, which may be updated over time as further discussed herein.

Thus, to eliminate the need to repeat the encrypted setup mode 308, the processing circuitry 452, the logic circuitry 458, and/or other suitable components of the secondary device 450 may encrypt the common seed 418 using the pre-shared key 412 to generate a sensor data encryption key. As further discussed below with reference to FIG. 5, this sensor data encryption key may then be used to perform the encryption operations on the data transmitted by the secondary device 450. For instance, and as shown in FIG. 5, the secondary device 450 may encrypt the common seed 418 with the pre-shared key 412 using any suitable predetermined encryption function. To provide some examples, the predetermined encryption function include a hashing operation, AES, ASCON, PRESENT, etc. Regardless of the type of encryption that is performed, this results in the generation of the sensor data encryption key 502.

For the example used with reference to FIG. 5, the pre-shared key 412 and the common seed 418 are each assumed to be 128 bits in length, and thus the sensor data encryption key 502 is likewise assumed to be 128 bits in length, or 16 bytes. Thus, each of the 16 blocks of the sensor data encryption key 502 as shown in FIG. 5 corresponds to a single byte value. However, it is noted that the common seed 418 and the pre-shared key 412 may be of any suitable bit length, which may be a function of the particular predetermined encryption function that is implemented, and thus the sensor data encryption key 502 may likewise have any suitable bit length.

The sensor data encryption key 502 is shown in FIG. 5 mapped to a 4×4 block of bytes to demonstrate the use of a single common seed 418 to encrypt up to four SPC communication frame transmissions. This assumes that 128 bit values as noted above are used for the common seed 418, the pre-shared key 412, and the sensor data encryption key 502, as well as a 6 nibble (3-byte) transmission of sensor data that is encrypted per SPC frame transmitted by the secondary device 450. However, the number of bytes is also used as an illustrative example and for ease of explanation, and any suitable number of bytes may be included with transmitted encrypted SPC frames, with the understanding that the common seed 418 may need to updated more or less frequently in accordance with the number of bytes in each encrypted SPC communication frame.

Continuing this example, the sensor data encryption key 502 is mapped to four rows, with each row being used to provide the encrypted sensor data for a single SPC frame transmission, which again may include 3 bytes in this example. With continued reference to FIG. 5, the sensor data that is encrypted per transmitted SPC frame may include the 6 nibbles of data as discussed herein with respect to FIG. 3 for instance. For example, the sensor data may include the 6 nibbles of encoded data such as the status nibble, the 3 data nibbles (e.g. data generated via the sensor circuitry 454), the rolling counter, and the CRC value. Thus, as the primary device 402 requests sensor data from the secondary device 450, the secondary device 450 may use different bytes of the sensor data encryption key 502, which are shown in FIG. 5 as divided into different rows, to encrypt the sensor data for each respective transmission.

Thus, once a predetermined number of transmissions have been sent by the secondary device 450 (4 in this example), the primary and secondary devices 402, 450 may each update their respective common seeds 418. This may include, for example, incrementing the previously-used 128-bit value, which is then encrypted by the secondary device 450 to generate another 16-byte sensor data encryption key 502 that is used for the next 4 encrypted SPC communication frame transmissions. The primary and secondary devices 402, 450 may each maintain a synchronized record of the number of received SPC communication frames (e.g. at the primary device 402) as well as a record of the number of transmitted SPC communication frames (e.g. at the secondary device 450). This may be achieved, for instance, via the use of the session counters 424, 474, which may also be stored in the non-volatile memories 410, 460. The use of the session counters is discussed in further detail below, and may represent any suitable length of bits that is used to maintain a history of SPC communications used to update the common seed 418 by the primary and secondary devices 402, 450 for this purpose. In this way, because the common seed 418 is encrypted to provide the sensor data encryption key 502, the common seed 418 may be incremented to update the sensor data encryption key 502 without re-executing the encrypted setup mode 308 and without re-transmitting the encrypted primary and secondary device seeds 414, 416 as part of this process.

With continued reference to FIG. 5, it is thus noted that the encryption process performed by the secondary device 450 using the sensor data encryption key 502 is discussed for a single SPC communication frame of encrypted sensor data. However, this process may be repeated in the same manner for subsequent transmissions with the same sensor data encryption key 502 (e.g. up to four consecutive transmissions of 3 bytes of sensor data each), as well as for subsequent transmissions after the four frame transmissions using an updated sensor data encryption key 502, as discussed herein.

To do so, it is first noted that the sensor data in this example includes three bytes of data, which are shown in FIG. 5, with each bit of the three bytes of sensor data being assigned a letter A-X for clarity. The processing circuitry 452, the logic circuitry 458, and/or other suitable components of the secondary device 450 is configured to perform the encryption process with respect to the three bytes of sensor data to encrypt the sensor data using the sensor data encryption key 502.

As part of this process, the secondary device 450 may initially bit-shift the sensor data by a number of bits that is based upon a byte value of a predetermined byte position within the sensor data encryption key 502. For example, the least significant byte in each row of the sensor data encryption key 502 is represented as bytes 0, 4, 8, and 12, and in this example each represents an encoded value that sets the bit-shift value for each transmitted frame. That is, each of the bytes of the sensor data encryption key 502 contains an encoded value between 0 and 255, and the value of the bytes 0, 4, 8, and 12 is used (per SPC frame transmission) to perform the bit-shifting operation. For instance, and with respect to the first row of the sensor data encryption key 502 that is used as an example, the value of the 0 byte is assumed to be ‘2,’ and thus the bits of the sensor data are shifted to the right by this value. Values exceeding the number of bits in the sensor data would result in the bits being shifted such that values having multiples of 24 bits result in no bit shifting of the sensor data.

Next, the secondary device 450 may combine the bit-shifted sensor data with the remaining bytes of the sensor data encryption key 502 in accordance with a predetermined logic function. For example, the logic circuitry 458 may combine the bit-shifted sensor data with the sensor data encryption key 502 based upon predetermined byte positions of bytes within sensor data encryption key 502. Thus, and as shown in FIG. 5, the secondary device 450 (e.g. the logic circuitry 458) may perform the encryption process with respect to the three bytes of the sensor data by performing any suitable bit-wise predetermined logic operation between the bit-shifted sensor data and a portion of the sensor data encryption key 502 having a number of bits equal to those of the bit-shifted sensor data. To provide an illustrative example, this includes the bit-shifted sensor data represented as bits W-V as shown in FIG. 5 being XOR-ed bit-wise with the bits corresponding to the byte positions 1, 2, and 3 of the sensor data encryption key 502. The result of this operation provides the encrypted sensor data as shown in FIG. 5.

The secondary device 450 may then transmit (e.g. via the communication circuitry 456) the encrypted sensor data to the primary device 402. This may include, for instance, the communication circuitry 456 transmitting the encrypted sensor data in accordance with an SPC protocol using 6 data nibbles as shown in FIG. 3 for instance. However, it is understood that the data nibble positions may not correlate directly with the standard SPC order of nibble positions as shown in FIG. 3. Thus, the primary device 402 may decrypt the encrypted sensor data to reconstruct the original, unshifted three bytes of sensor data to obtain the same information as if the data was transmitted via a conventional, unencrypted SPC protocol.

For instance, for each SPC frame that is received by the primary device 402 including the encrypted sensor data, the primary device 402 (e.g. via the processing circuitry 404, the logic circuitry 408, and/or other suitable components) is configured to generate the sensor data encryption key 502. This may be performed in the same manner as that described above with respect to the secondary device 450. For example, the primary device 402 may use the common seed 418 and the pre-shared key 412 to generate the sensor data encryption key 502. The primary device 402 may do so prior to or subsequent to receiving the encrypted sensor data, in various embodiments.

The processing circuitry 404, the logic circuitry 408, and/or other suitable components of the primary device 402 are configured to decrypt the encrypted sensor data received from the secondary device 450. This may include, for example, combining the encrypted sensor data and the sensor data encryption key 502 using the same (e.g. XOR) predetermined logic function that was used by the secondary device 450 to provide the bit-shifted sensor data. Next, the secondary device 450 may then identify, using the value of the predetermined (e.g. byte 0) byte position of the sensor data encryption key 502, the bit-shifted value. The primary device 402 may then un-shift the bit-shifted sensor data by the number of bits identified with this determine value (e.g. 2) to recover the original sensor data that was generated by the secondary device 450.

Again, this process may be repeated up to four times with the same the sensor data encryption key 502. As an illustrative example, the next SPC communication frame would use the value of bit position 4 to shift the bits of the sensor data, with the bit-shifted data then being XORed with the bytes 5, 6, and 7, and so on for the remaining two transmissions.

Thus, the embodiments described in this Section enable an encrypted data transfer between devices in accordance with the SPC protocol. The embodiments advantageously produce no additional latency due to post encryption or the additional bit transfer, given the ability to perform bit-shifts and XOR operations via hardware components. Additionally, the embodiments described in this Section enable a detectable data corruption during communication transfer (e.g. via CRC verification), and support data authentication given that the primary and secondary devices 402, 450 use pre-shared keys. This may enable, for example, the encrypted data to be sent in addition to a signature. Moreover, these embodiments are robust against replay attacks in light of the use of the initial generation of the common seed during the encryption setup mode 308.

### Section II. Seed Optimization

As noted above, the encrypted setup mode 308 may include the primary device 402 transmitting encrypted primary device seed data to the secondary device 450. This encrypted primary device seed data may comprise the entirety of the encrypted primary device seed 414, as noted above. In other words, in the embodiments discussed in Section I, it was assumed that the entirety of the generated primary device seed 414 was encrypted and then transmitted to the secondary device 450 as the encrypted device seed data. However, it is noted that because the primary device seed 414 may have a bit length of 128 bits or more for example, this may require a significant amount of time during the encrypted setup mode 308.

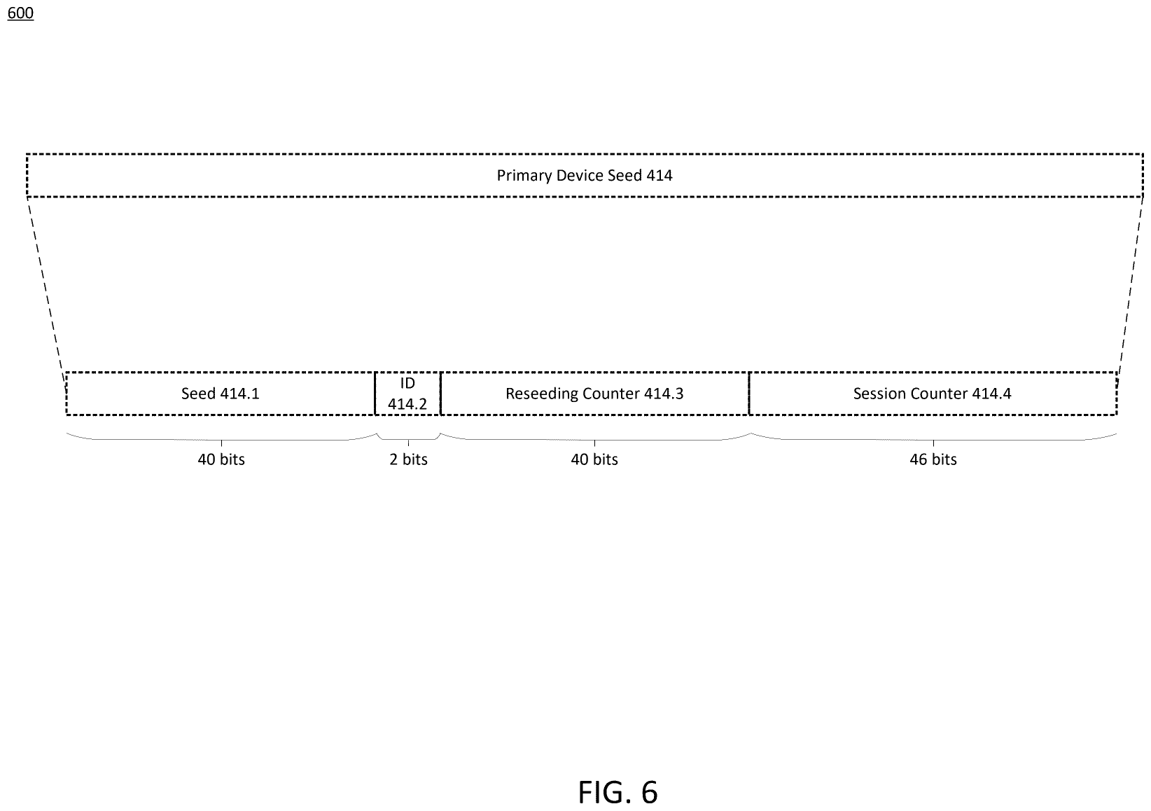

Therefore, the embodiments as described in this Section are directed to reducing the size of the encrypted device seed data by including only a portion of the primary device seed 414 that is encrypted and transmitted instead of the entire encrypted primary device seed 414. To do so, reference is now made to FIG. 6, which illustrates an example of an alternate primary device seed, in accordance with one or more embodiments of the disclosure. The alternate primary device seed 414 is shown in FIG. 6 in plaintext, comprises a bit string of 128 bits, and is shown including four fields, each being assigned a specific number of bits. The primary device seed 414 may have any suitable predetermined number of bits, be generated by the primary device 402 as discussed in Section I above, and may be stored as part of the primary device seed 414 in the non-volatile memory 410 of the primary device 402 as well as the non-volatile memory 460 of the secondary device 450. Each of the other fields of the primary device seed 414 also comprise respective bit strings having a predetermined number of bits, which may likewise be stored in the non-volatile memory 410 of the primary device 402 as well as the non-volatile memory 460 of the secondary device 450, as shown in FIG. 4.

As one illustrative example, the primary device seed 414 includes a 40 bit seed 414.1, a 2-bit identifier 414.2, a 40-bit reseeding counter 414.3, and a 46-bit session counter 414.4. However, the primary device seed 414 as shown and discussed with respect to FIG. 6 may be of any suitable bit length, have any suitable number of fields, and each of these fields may include any suitable number of respective bits. Moreover, the primary device seed 414 may include additional, fewer, or alternate fields than those shown.

Thus, in accordance with such embodiments, the initial step as discussed above with respect to the encrypted setup mode 308 may include the primary device 402 generating the seed 414.1 as a bit string having a length of 40 bits. Thus, the processing circuitry 404, the logic circuitry 408, and/or other suitable components of the primary device 402 may be configured to generate the device seed 414.1 in accordance with any suitable cryptographic function, such as a random seed generating function for instance, that outputs, as the seed 414.1, a random bit string.

In some embodiments, this may include using the same cryptographic function as discussed in Section I above to initially generate a full-length seed, which may then be truncated or otherwise recued in any suitable manner to generate the seed 414.1. In other embodiments, the primary device 402 may implement an alternate cryptographic function to generate the reduced length seed 414.1. The primary device 402 may thus encrypt the seed 414.1 using a truncated portion of the pre-shared key 412 or, alternatively, by truncating the result of encrypting the full-length primary device seed using the pre-shared key 412. The resulting data may thus represent the encrypted device seed data (but reduced to 40 bits in length in this example) that is transmitted to the secondary device 450 in the same manner as discussed in Section I above.

This reduction in bits is sufficient for the encrypted SPC communications over a lifetime of operation of the primary and secondary devices 402, 450. For instance, it is assumed that the amount of data transmitted by the secondary device 450 over an operating lifetime comprises 20,000 operating hours with ˜275 μs frame length results in 2.6e11 frames in total. Because 4 frames may be transmitted for each seed incrementation, this results in the need for 2\hat{ }36 seeds. And because the SPC protocol transmits 4 bit nibbles, a total of 40 bit (10 nibbles) as seed values are sufficient to capture an overflow free, lifetime operation.

Turning now to the other fields of the primary device seed 414 as shown in FIG. 6, it is noted that the primary and secondary devices 402, 450 still use the 128-bit length primary device seed 414 to obtain the common seed 418, as discussed above with respect to Section I. However, the primary and secondary devices 402, 450 are configured to reconstruct the primary device seed 414 using data from the remaining fields 414.2, 414.3, 414.4, which are stored or otherwise known to each of the primary and secondary devices 402, 450 as noted above. For example, the secondary device 450 receives the encrypted device seed data transmitted by the primary device 402 as discussed in Section I above, and then derives and stores the entire primary device seed 414 in the non-volatile memory 460, which is used to generate and store the common seed 418.

Thus, the processing circuitry 452, the logic circuitry 458, or any other suitable components of the secondary device 450 may be configured to first decrypt the encrypted device seed data (which again comprises the encrypted 40-bit seed 414.1 in this example) using the pre-shared key 412 (or truncated portion thereof) to obtain the seed 414.1 as shown in FIG. 6. Then, the secondary device 450 may concatenate the seed 414.1 with the other fields 414.2, 414.3, 414.3, each being stored in the non-volatile memory 460 of the secondary device 450 or otherwise known to the secondary device 450, to derive the entire primary device seed 414, which is then stored in the non-volatile memory 460 and further utilized as discussed in Section I above.

It is noted that the 2-bit ID field 414.2 may represent an identifier for the secondary device 450, which may be one device from among several in communication with the primary device 402. The ID field 414.2 may, for example, be defined in accordance with the SPC communication protocol, which assigns such ID fields to each sensor connected to the bus that communicates with the primary device 402. Thus, the 2-bit ID field serves as an address of the secondary device 450 that may be predetermined or established via communications between the primary device 402 and each of the secondary devices such that the secondary device 450 may respond to communications received from the primary device 402 only when the ID field 414.2 matches that known (e.g. stored) by the secondary device 450. In the present scenario, the use of 2-bits allows for support of up to four secondary devices. In this way, the same process as discussed herein may be extended to any suitable number (e.g. four in this example) of other secondary devices. Thus, it is ensured that the primary device seed 414 is unique for communications between the primary device 402 and each of these other secondary devices, despite the same 40-bit seed 414.1 being transmitted to each of the secondary devices 450 during the encrypted setup mode 308.

The primary device seed 414 also includes a reseeding counter field 414.3 and a session counter field 414.4, as shown in FIG. 6. The primary and secondary devices 402, 450 each stores these counter values in their respective non-volatile memories 410, 460 as shown in FIG. 4. The re-seeding counter field 414.3 and the session counter field 414.4 are discussed in further detail below in Section III. It is noted that the reseeding counter field 414.3 and the session counter field 414.4 may each represent starting (e.g. predetermined or default) values that are established during the encrypted setup mode 308.

### Section III—Re-Seeding of the Common Seed

Again, the re-seeding counter field 414.3 and the session counter field 414.4 of the primary device seed 414 each have values that are established during the encrypted setup mode 308. Thus, during the encrypted setup mode 308, the primary and the secondary device 402, 450 store the same value for the reseeding counter field 414.3 and the session counter field 414.4, which represent starting values that are indicative of an initial or reset state. Then, during subsequent communications during the operating mode 306, the values of the reseeding counter field 414.3 and/or the session counter field 414.4 may be updated, as further discussed below.

For instance, the session counter field 414.4 may comprise any suitable value, which may have a predetermined or default value (e.g. zero) that is initially established by the secondary device 450 and known by the primary device 402 as a result of the encrypted setup mode 308. Each of the primary and secondary devices 402, 450 is configured (e.g. via the processing circuitry 404, 452, the logic circuitry 408, 458, or any suitable components thereof) to increment the value of the session counter field 414.4 that is stored in each of the non-volatile memories 410, 460 in response to a threshold number of communication frames being transmitted by the secondary device 450 and received from the primary device 402. To provide an illustrative example using the scenario discussed above, the secondary device 450 may increment its locally-stored session counter field 414.4 (the session counter 474) each time a communication frame is transmitted, and the primary device 402 may likewise increment its locally-stored session counter field 414.4 (the session counter 424) each time a communication frame is received from the secondary device 450.

In this way, the primary and the secondary devices 402, 450 may maintain a synchronized use of the common seed 418. This may be used, for instance, by the primary and the secondary devices 402, 450 to ensure that the same predetermined byte positions of the sensor data encryption key 502 as discussed above with respect to FIG. 5 to perform the encryption and decryption functions. That is, the primary and the secondary devices 402, 450 may each increment and reference their locally-stored session counter field 414.4 to identify which “row” of the sensor data encryption key 502 as shown in FIG. 5 is currently being used for a particular encrypted SPC frame transmission. Additionally, the primary and the secondary devices 402, 450 may reference their locally-stored session counter field 414.4 to determine when to increment their locally-stored common seed 418 (e.g. after four encrypted SPC frame transmissions, as noted above), to thereby generate an updated sensor data encryption key 502 for the next four frame transmissions. In this way, the session counter field 414.4 stored by each of the primary and the secondary devices 402, 450 enables a synchronization of the particular portions of the common seed 418 used for each transmitted frame as well as a synchronization of the common seed 418 itself.

The re-seeding counter field 414.3 may also comprise any suitable value, which may have a predetermined or default value (e.g. zero) that is initially established by the secondary device 450 and known by the primary device 402 as a result of the encrypted setup mode 308. The reseeding counter field 414.3 may thus have an initial, predetermined value associated with an initial or reset state, which may be different than or the same as the starting value of the session counter field 414.4 as discussed above. For example, the reseeding counter field 414.3 may have a starting value of all zeroes or any other suitable value. Thus, the primary and the secondary devices 402, 450 may each store the reseeding counter field 414.3 in their respective non-volatile memories 410, 460 (reseeding counters 422, 472), as shown in FIG. 4.

The primary device 402 may (e.g. via the processing circuitry 404) increment the value of the reseeding counter field 414.3 in response to one or more predetermined conditions being met. The one or more predetermined conditions may comprise, for instance, the detection of a synchronization error between the primary device 402 and the secondary device 450 upon decrypting an encrypted sensor data transmission. As an illustrative example, the processing circuitry 404 may detect such a synchronization error based upon a threshold number of CRC failures being exceeded.

In response to such predetermined conditions being satisfied, the processing circuitry 404 may increment the re-seeding counter field 414.3 stored in the non-volatile memory 410 and also reset the value of the session counter field 414.4 to the initial value that was established during the encrypted setup mode 308. The primary device 402 may then use the updated primary device key to update the common seed 418. Additionally, and in response to such predetermined conditions being satisfied, the secondary device 450 may also update the values of its locally stored reseeding counter field 414.3 (reseeding counter 472) and the session counter field 414.4 (session counter 474) to update its locally-stored primary device seed 414. The secondary device 450 may also update the common seed 418 in the same manner as discussed above, which results in the synchronization of the common seed 418 stored in the primary and secondary devices 402, 450.

To ensure this synchronization of the primary device seed 414 and, in turn, the common seed 418, upon incrementing the reseeding counter field 414.3 and resetting the value of the session counter field 414.4, the primary device 402 may then transmit a reseeding command to the secondary device 450. This reseeding command may implement, for example, an additional trigger pulse signal that is transmitted as part of an SPC communication frame to the secondary device 450. For instance, the additional trigger pulse signal may comprise a length of time that exceeds that identified with a conventional SPC communication protocol. This second trigger pulse may nonetheless be recognized by the secondary device 450 after the initial trigger pulse signal identifies the secondary device 450 as the recipient of the frame by way of the time-encoding of the length of the first, standardized SPC pulse signal, as is generally known. For example, the communication circuitry 456 may be configured to recognize the second trigger pulse signal length as a reseeding command by comparing the length of the trigger pulse signal (e.g. from a rising to a falling edge) to a threshold value, and determining that a reseeding command has been received when this time period exceeds a threshold value.

Thus, upon recognizing this reseeding command, the processing circuitry 452 may update the values of its locally stored reseeding counter field 414.3 and session counter field 414.4 to thereby update the primary device seed 414. Once the primary device seed 414 is updated in this manner, the secondary device 450 may also update the stored common seed 418 as discussed above by combining the primary device seed 414 and the secondary device seed 416. In this way, the primary and secondary devices 402, 450 may synchronize the common seed 418 without a restart and without the need for the transmission of the entire primary seed as discussed during the encrypted setup mode 308.

### IV. The use of an Alternative Sponge-Based Encryption

For the embodiments described in Sections I, II, and III, the secondary device 450 may utilize the sensor data encryption key 502 to encrypt the entirety of the sensor data, which may then be transmitted to the primary device 402. These embodiments may be particularly advantageous for AEAD implementations. However, it may be desirable to utilize secured SPC communications to alternatively provide authentication only implementations. For example, in accordance with such embodiments, secured communications may be used to authenticate the secondary device 450, whereas the entire sensor data or a portion thereof may be transmitted in plaintext.

The sponge-based encryption embodiments described in this Section may enable such implementations. For example, the CRC value that was discussed in the Sections above may be used for this purpose, or be further expanded beyond a single nibble size to any suitable predetermined number of bits. This CRC value expansion may be performed in any suitable manner, including known techniques to do so. The remainder of the sensor data as discussed above (e.g. the status nibble, data nibbles, and rolling counter) may then be transmitted in plaintext instead of being encrypted as discussed in the Sections above. Alternatively, the sponge-based encryption as discussed in this Section may be used for AEAD implementations as well. Thus, the embodiments described in this Section may implement both authentication only and AEAD schemes, as further discussed herein.

The sponge-based encryption algorithms discussed in this Section may thus be used in place of the bit-shifting and XOR operations performed on the sensor data with the predetermined byte portions of the sensor data encryption key 502, as shown and discussed herein with respect to FIG. 5 for instance. The sponge-based encryption embodiments described in this Section provide enhanced security, as attackers may test the shift value as one of 24 possibilities, and then select d =Δ∥crc(Δ) to construct a forgery c′ for a ciphertext c with probability of the form c′=(c xor d)>>bit shift value, as the crc is a linear function.

Before proceeding with a further explanation of these embodiments, it is prudent to provide additional details regarding sponge-based encryption. It is noted in this regard that sponge-based encryption is a type of encryption that uses sponge functions, which are algorithms that can produce output bit streams of any length from input bit streams of any length. For instance, a sponge construction may comprise a mode of operation that is based on a fixed-length permutation (or transformation) and on a padding rule, which builds a function mapping variable-length input to variable-length output. Such a function is called a sponge function. Both SHA-3 (Secure Hash Algorithm 3, the latest member of the Secure Hash Algorithm family of standards, released by NIST on August 5, 2015) and ASCON are based on such sponge constructions. The embodiments described in this Section in further detail may implement any suitable sponge-based constructions, including known types. In doing so, the embodiments described in this Section provide increased flexibility and the option to implement authentication only schemes.

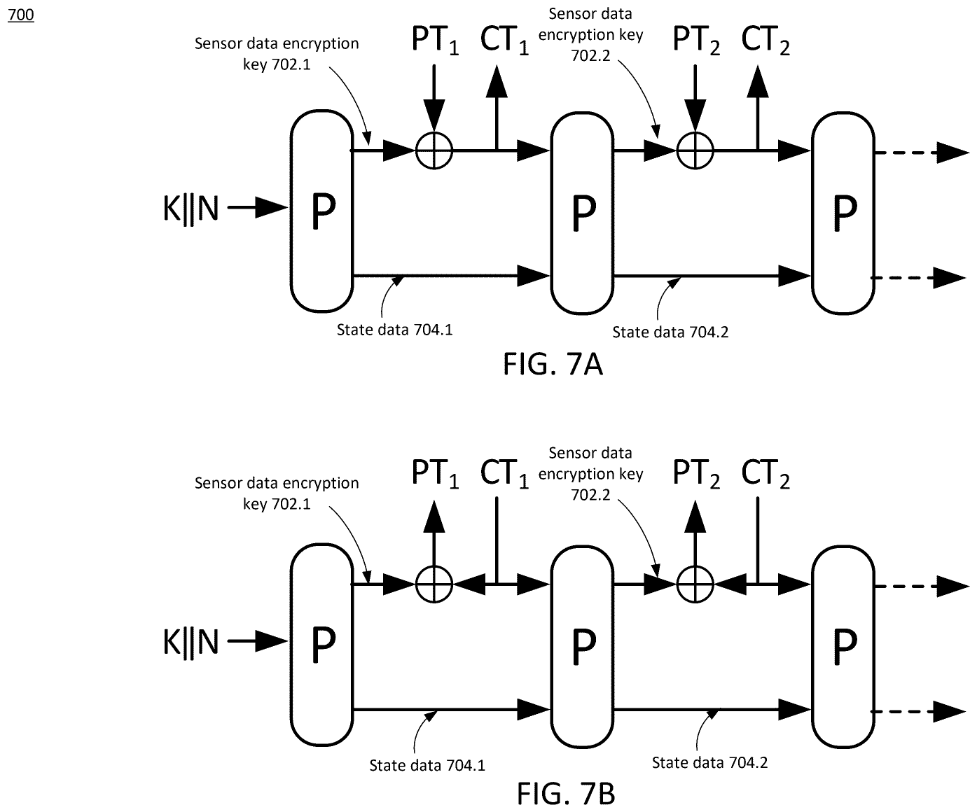

FIG. 7A illustrates a sponge-based encryption, in accordance with one or more embodiments of the disclosure. The sponge-based encryption process as shown in FIG. 7A may be implemented via the secondary device 450 to generate the encrypted sensor data that is transmitted to the primary device 402. The secondary device 450 may implement any suitable components to do so, which may include for example the processing circuitry 452, the logic circuitry 458, dedicated hardware components such as hardware accelerators, etc. The dedicated hardware components may comprise part of the processing circuitry 452 and/or the logic circuitry 458, for example, or separate components (not shown). Additionally or alternatively, the secondary device 450 may implement the sponge-based encryption process via software or combinations of software and hardware. Software-based implementations may be performed, for instance, via the processing circuitry 452 executing the instructions stored in the program memory 470.

In any event, the secondary device 450 is configured to encrypt at least a portion of the sensor data in accordance with a predetermined cryptographic sponge function to generate the encrypted sensor data. To do so, the predetermined cryptographic sponge function may receive, as inputs, the pre-shared key 412 (K) and the common seed 418 (N), which may be generated and stored in the non-volatile memory 460 as discussed above. The predetermined cryptographic sponge function as shown in FIG. 7A is configured to interconnect a set of permutation matrices P as shown, and thus the first permutation matrix generates an output of three bytes (in this example, although any suitable length of input data and output data may be implemented) from the pre-shared key 412 (K) and the common seed 418 (N), which may alternatively be referred to herein as a sensor encryption key 702.1. The first stage of the predetermined cryptographic sponge function also receives, as an input, plaintext (PT1) data representing the sensor data as discussed above with respect to FIG. 5.

Thus, for the example as shown in FIG. 7A, the sensor data PT1 is XORed with the sensor encryption key 702.1 output via the first permutation matrix but without bit-shifting the sensor data, thereby generating the encrypted sensor data as the ciphertext (CT1). However, in accordance with the present embodiments, the use of the predetermined cryptographic sponge function allows for the ciphertext CT1 to represent an entirety of the sensor data that is encrypted or any portion thereof (e.g. the CRC or an expanded CRC, as noted above). Thus, the encrypted sensor data in accordance with the present embodiments (e.g. CT1) may include any suitable portion of the sensor data, or the entirety of the sensor data, that may then be transmitted as encrypted sensor data while remaining portions of the sensor data may be transmitted in plaintext. In this way, the communication circuitry 456 may be configured to transmit the encrypted sensor data (e.g. the CRC value) and plaintext sensor data (e.g. the other transmitted nibbles) to the primary device 402 in accordance with an authentication only scheme.

Again, the predetermined cryptographic sponge function includes a set of interconnected permutation matrices as shown in FIG. 7A, such that the output of each previous stage (P) is used as an input to the next stage. For instance, the ciphertext CT1 that is generated as part of the first stage is fed into the next permutation matrix along with the internal state data 704 as shown in FIG. 7A. The internal state data 704 may comprise any suitable information regarding an internal state of the sponge constructions, and may be generated in accordance with any suitable techniques, including known techniques used for cryptographic sponge functions.

Thus, each one of the permutation matrices P may receive, as inputs, data representing the encrypted sensor data that was previously generated by the secondary device 450 and transmitted to the primary device 402. In this way, each subsequent stage of the predetermined cryptographic sponge function (after the initial stage) is configured to generate the encrypted sensor data CT that is transmitted to the primary device 402 using the sensor data encryption key 702 that is output from the previous stage. The sensor data encryption key 702 output via each stage is, in turn, generated based upon the previously-transmitted encrypted sensor data CT1 and the internal state data 704 from the previous stage. Thus, the sensor data encryption key 702 is computed at each subsequent stage using data from the previous stage.

To provide an illustrative example, the secondary device 450 may generate the encrypted sensor data CT2 at the second stage as shown in FIG. 7A by encrypting any suitable portion of the sensor data PT2 (e.g. a CRC value) using the sensor data encryption key 702.2. This sensor data encryption key 702.2 is generated using any suitable techniques, including known techniques used for sponge-based cryptography, that processes the encrypted sensor data and state data from the prior stage (e.g. the previous frame transmission). This process may then be repeated for each subsequent SPC frame transmission such that the level of security is significantly increased over time with increasing numbers of transmissions.

Furthermore, FIG. 7B illustrates a sponge-based decryption, in accordance with one or more embodiments of the disclosure. The primary device 402 may receive each encrypted sensor data transmission from the secondary device. The primary device 402 may likewise implement any suitable components to perform the sponge-based decryption process. For instance, the primary device 402 may implement the processing circuitry 404, the logic circuitry 408, dedicated hardware components, software components (e.g. processing circuitry 404 executing instructions stored in the program memory 410), or combinations of these to implement the sponge-based decryption process.

As shown in FIG. 7B, the primary device 402 stores the same pre-shared key 412 (K) and common seed 418 (N) used by the secondary device 450 to perform the encryption of the sensor data. Additionally, the primary device 402 may implement the same predetermined cryptographic sponge function as that implemented by the secondary device 450. As a result, the predetermined cryptographic sponge function generates the sensor data encryption keys 702 in the same manner as discussed above for FIG. 7A, which may include using the encrypted sensor data CT and state data 704 from previous data frames that have been received from the secondary device 450. The predetermined cryptographic sponge function thus receives, as inputs, the encrypted sensor data (CT1, CT2, etc.) and state data 702 per transmission/stage. Thus, the decryption process includes using the computed sensor data encryption key 702 per transmission of encrypted sensor data to decrypt the data to provide the plaintext sensor data PT1, PT2, etc., as shown in FIG. 7B.

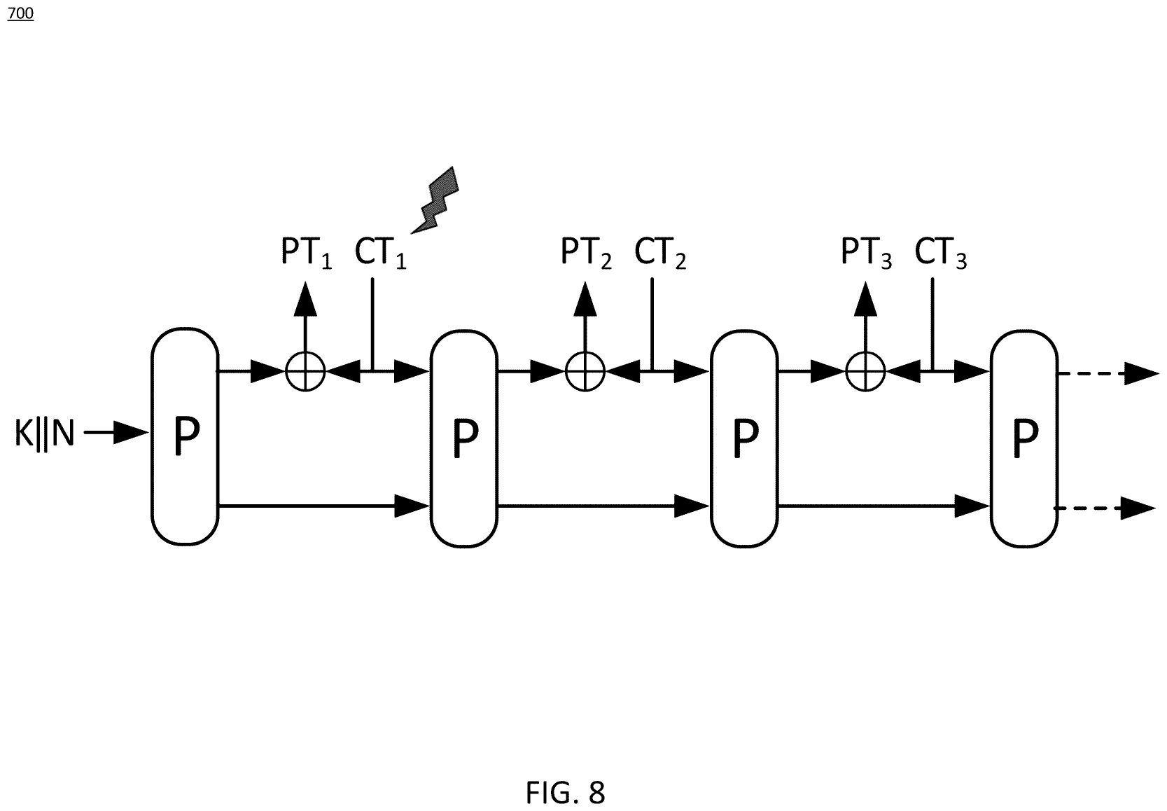

FIG. 8 illustrates the robustness of a sponge-based encryption to forgery attacks, in accordance with one or more embodiments of the disclosure. With respect to FIG. 8, it is assumed that an error has been introduced into the generation of the encrypted sensor data CT1, which is assumed to be the CRC value in this example. This will be then be detected by the primary device 402 upon decrypting the encrypted sensor data (PT2), with a probability of 1-2^{-t}, with t denoting the size of the CRC in bits. However, because PT3 also depends on CT1, the error will also be detected by the CRC in PT3 with the same probability resulting in a total probability of 1-2^{-2t}, and so on. In this way, the security of the sponge construction against forgery attacks is significantly increased with increasing data transmissions.

### EXAMPLES

The techniques of this disclosure may also be described in the following examples.

Example 1. A device configured to communicate with a sensor using a pulse width modulation (PWM) code protocol, the device comprising: communication circuitry configured to transmit, in accordance with the PWM code protocol, encrypted device seed data that includes at least a portion of a device seed that is encrypted, and to receive in response an encrypted sensor seed from the sensor in accordance with the PWM code protocol; processing circuitry configured to decrypt the encrypted sensor seed to generate a sensor seed; and logic circuitry configured to generate a common seed based upon a combination of the device seed and the sensor seed, wherein the processing circuitry is configured to decrypt encrypted sensor data received from the sensor in accordance with the PWM code protocol using the common seed to obtain sensor data measured by the sensor.

Example 2. The device of Example 1, wherein the logic circuitry is configured to generate the common seed as part of an encrypted setup mode of operation that occurs prior to an operating mode of communications between the device and the sensor.

Example 3. The device of any combination of Examples 1-2, wherein the processing circuitry is configured to generate the encrypted device seed data by encrypting at least a portion of the device seed using a predetermined encryption function that utilizes a pre-shared key that is shared by the device and the sensor.

Example 4. The device of any combination of Examples 1-3, wherein the processing circuitry is configured to decrypt the encrypted sensor seed using a predetermined encryption function that utilizes a pre-shared key that is shared by the device and the sensor.

Example 5. The device of any combination of Examples 1-4, wherein the logic circuitry is configured to generate the common seed by combining the device seed and the sensor seed using a predetermined logic function.

Example 6. The device of any combination of Examples 1-5, wherein the predetermined logic function comprises an exclusive OR (XOR) function.

Example 7. The device of any combination of Examples 1-6, wherein the processing circuitry is configured to generate a sensor data encryption key, which was used by the sensor to generate the encrypted sensor data, using the common seed and a pre-shared key that is shared by the device and the sensor.

Example 8. The device of any combination of Examples 1-7, wherein the processing circuitry is configured to decrypt the encrypted sensor data received from the sensor by combining the encrypted sensor data and the sensor data encryption key using an exclusive OR (XOR) function to provide bit-shifted sensor data, and to unshift the bit-shifted sensor data by a number of bits that is based upon a byte value of a predetermined byte position within the sensor data encryption key.

Example 9. The device of any combination of Examples 1-8, wherein the processing circuitry is configured to generate the device seed in accordance with a random seed generating function that outputs, as the device seed, a random bit string.

Example 10. The device of any combination of Examples 1-9, wherein the device seed comprises a plurality of fields, and wherein the processing circuitry is configured to generate the device seed in accordance with a random seed generating function that outputs, as a first one of the plurality of fields, a random bit string.

Example 11. The device of any combination of Examples 1-10, wherein the processing circuitry is configured to generate the encrypted device seed data by encrypting the random bit string of the first one of the plurality of fields of the device seed, and wherein the communication circuitry is configured to transmit, as the at least the portion of the device seed that is encrypted, the encrypted random bit string.

Example 12. The device of any combination of Examples 1-11, wherein other ones of the plurality of fields of the device comprise respective bit strings having a predetermined number of bits that are stored in a memory of the device.

Example 13. The device of any combination of Examples 1-12, wherein other ones of the plurality of fields of the device seed comprise respective bit strings having a predetermined number of bits that are stored in a memory of the sensor.

Example 14. The device of any combination of Examples 1-13, wherein the sensor is configured to derive the device seed by decrypting the encrypted random bit string and concatenating the first one of the plurality of fields with the other ones of the plurality of fields stored in the memory of the sensor.

Example 15. The device of any combination of Examples 1-14, wherein a second one of the plurality of fields of the device seed comprises a bit string indicative of a session counter, and wherein the processing circuitry is configured to increment the session counter in response to a threshold number of communication frames being received from the sensor.

Example 16. The device of any combination of Examples 1-15, wherein a third one of the plurality of fields of the device seed comprises a bit string indicative of a reseeding counter, and wherein the processing circuitry is configured to increment the reseeding counter in response to resetting the session counter to thereby synchronize the common seed stored in the device and the sensor.

Example 17. The device of any combination of Examples 1-16, wherein the processing circuitry is configured to increment the reseeding counter in response to a synchronization error that is detected between the device and the sensor upon decrypting the encrypted sensor data.

Example 18. A sensor configured to communicate with a device using a pulse width modulation (PWM) code protocol, the sensor comprising: sensor circuitry configured to generate sensor data indicative of a sensor measurement; communication circuitry configured to receive, via a device in accordance with the PWM code protocol, encrypted device seed data that includes at least a portion of a device seed that is encrypted; processing circuitry configured to decrypt and generate the device seed; and logic circuitry configured to generate a common seed based upon a combination of the device seed and a sensor seed, wherein at least a portion of the sensor data is encrypted using the common seed to provide encrypted sensor data, and wherein the communication circuitry is configured to transmit the encrypted sensor data to the device in accordance with the PWM code protocol.

Example 19. The sensor of Example 18, wherein the logic circuitry is configured to encrypt the common seed in accordance with a predetermined encryption function to generate a sensor data encryption key, and to encrypt the sensor data using the sensor data encryption key.

Example 20. The sensor of any combination of Examples 18-19, wherein the logic circuitry is configured to encrypt the sensor data by: bit-shifting the sensor data by a number of bits that is based upon a byte value of a predetermined byte position within the sensor data encryption key; and performing an exclusive OR (XOR) operation on (i) the bit-shifted sensor data, and (ii) a portion of the sensor data encryption key having a number of bits equal to the bit-shifted sensor data.

Example 21. The sensor of any combination of Examples 18-20, wherein the processing circuitry is configured to decrypt the encrypted device seed data using a predetermined encryption algorithm that utilizes a pre-shared key that is shared by the device and the sensor.

Example 22. The sensor of any combination of Examples 18-21, wherein the logic circuitry is configured to generate the common seed by combining the sensor seed and the device seed using a predetermined logic function.

Example 23. The sensor of any combination of Examples 18-22, wherein the predetermined logic function comprises an exclusive OR (XOR) function.

Example 24. The sensor of any combination of Examples 18-23, wherein the processing circuitry is configured to encrypt at least the portion of the sensor data in accordance with a predetermined cryptographic sponge function to generate the encrypted sensor data.

Example 25. The sensor of any combination of Examples 18-24, wherein the predetermined cryptographic sponge function is configured to interconnect a set of permutation matrices, with one or more of the set of permutation matrices receiving, as inputs, data representing the encrypted sensor data that was previously generated by the sensor and transmitted to the device.

Example 26. The sensor of any combination of Examples 18-25, wherein the processing circuitry is configured to generate a sensor data encryption key in accordance with a predetermined cryptographic sponge function that receives, as inputs, the common seed and a pre-shared key that is shared by the device and the sensor.

Example 27. The sensor of any combination of Examples 18-26, wherein the processing circuitry is configured to generate the encrypted sensor data by encrypting, as the at least the portion of the sensor data, a cyclic redundancy check (CRC) value using the sensor data encryption key.

Example 28. The sensor of any combination of Examples 18-27, wherein the communication circuitry is configured to transmit a remainder of the sensor data other than the CRC value to the device as plaintext sensor data.

Example 29. The sensor of any combination of Examples 18-28, wherein the communication circuitry is configured to transmit the plaintext sensor data and the encrypted sensor data to the device in accordance with an authentication only scheme.

### Conclusion

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It is further to be noted that specific terms used in the description and claims may be interpreted in a very broad sense. For example, the terms “circuit” or “circuitry” used herein are to be interpreted in a sense not only including hardware but also software, firmware or any combinations thereof. The term “data” may be interpreted to include any form of representation data. The term “information” may in addition to any form of digital information also include other forms of representing information. The term “entity” or “unit” may in embodiments include any device, apparatus circuits, hardware, software, firmware, chips, or other semiconductors as well as logical units or physical implementations of protocol layers etc. Furthermore, the terms “coupled” or “connected” may be interpreted in a broad sense not only covering direct but also indirect coupling.

It is further to be noted that methods disclosed in the specification or in the claims may be implemented by a device having means for performing each of the respective steps of these methods.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This disclosure is intended to cover any adaptations or variations of the specific embodiments discussed herein.

What is claimed is:

1. A device configured to communicate with a sensor using a pulse width modulation (PWM) code protocol, the device comprising:
communication circuitry configured to transmit, in accordance with the PWM code protocol, encrypted device seed data that includes at least a portion of a device seed that is encrypted, and to receive in response an encrypted sensor seed from the sensor in accordance with the PWM code protocol;
processing circuitry configured to decrypt the encrypted sensor seed to generate a sensor seed; and
logic circuitry configured to generate a common seed based upon a combination of the device seed and the sensor seed,
wherein the processing circuitry is configured to decrypt encrypted sensor data received from the sensor in accordance with the PWM code protocol using the common seed to obtain sensor data measured by the sensor.

2. The device of claim 1, wherein the logic circuitry is configured to generate the common seed as part of an encrypted setup mode of operation that occurs prior to an operating mode of communications between the device and the sensor.

3. The device of claim 1, wherein the processing circuitry is configured to generate the encrypted device seed data by encrypting at least a portion of the device seed using a predetermined encryption function that utilizes a pre-shared key that is shared by the device and the sensor.

4. The device of claim 1, wherein the processing circuitry is configured to decrypt the encrypted sensor seed using a predetermined encryption function that utilizes a pre-shared key that is shared by the device and the sensor.

5. The device of claim 1, wherein the logic circuitry is configured to generate the common seed by combining the device seed and the sensor seed using a predetermined logic function.

6. The device of claim 5, wherein the predetermined logic function comprises an exclusive OR (XOR) function.

7. The device of claim 1, wherein the processing circuitry is configured to generate a sensor data encryption key, which was used by the sensor to generate the encrypted sensor data, using the common seed and a pre-shared key that is shared by the device and the sensor.

8. The device of claim 7, wherein the processing circuitry is configured to decrypt the encrypted sensor data received from the sensor by combining the encrypted sensor data and the sensor data encryption key using an exclusive OR (XOR) function to provide bit-shifted sensor data, and to unshift the bit-shifted sensor data by a number of bits that is based upon a byte value of a predetermined byte position within the sensor data encryption key.

9. The device of claim 1, wherein the processing circuitry is configured to generate the device seed in accordance with a random seed generating function that outputs, as the device seed, a random bit string.

10. The device of claim 1, wherein the device seed comprises a plurality of fields, and
wherein the processing circuitry is configured to generate the device seed in accordance with a random seed generating function that outputs, as a first one of the plurality of fields, a random bit string.

11. The device of claim 10, wherein the processing circuitry is configured to generate the encrypted device seed data by encrypting the random bit string of the first one of the plurality of fields of the device seed, and
wherein the communication circuitry is configured to transmit, as the at least the portion of the device seed that is encrypted, the encrypted random bit string.

12. The device of claim 10, wherein other ones of the plurality of fields of the device comprise respective bit strings having a predetermined number of bits that are stored in a memory of the device.

13. The device of claim 11, wherein other ones of the plurality of fields of the device seed comprise respective bit strings having a predetermined number of bits that are stored in a memory of the sensor.

14. The device of claim 13, wherein the sensor is configured to derive the device seed by decrypting the encrypted random bit string and concatenating the first one of the plurality of fields with the other ones of the plurality of fields stored in the memory of the sensor.

15. The device of claim 10, wherein a second one of the plurality of fields of the device seed comprises a bit string indicative of a session counter, and
wherein the processing circuitry is configured to increment the session counter in response to a threshold number of communication frames being received from the sensor.

16. The device of claim 15, wherein a third one of the plurality of fields of the device seed comprises a bit string indicative of a reseeding counter, and
wherein the processing circuitry is configured to increment the reseeding counter in response to resetting the session counter to thereby synchronize the common seed stored in the device and the sensor.

17. The device of claim 16, wherein the processing circuitry is configured to increment the reseeding counter in response to a synchronization error that is detected between the device and the sensor upon decrypting the encrypted sensor data.

18. A sensor configured to communicate with a device using a pulse width modulation (PWM) code protocol, the sensor comprising:
sensor circuitry configured to generate sensor data indicative of a sensor measurement;
communication circuitry configured to receive, via a device in accordance with the PWM code protocol, encrypted device seed data that includes at least a portion of a device seed that is encrypted;
processing circuitry configured to decrypt and generate the device seed; and
logic circuitry configured to generate a common seed based upon a combination of the device seed and a sensor seed,
wherein at least a portion of the sensor data is encrypted using the common seed to provide encrypted sensor data, and
wherein the communication circuitry is configured to transmit the encrypted sensor data to the device in accordance with the PWM code protocol.

19. The sensor of claim 18, wherein the logic circuitry is configured to encrypt the common seed in accordance with a predetermined encryption function to generate a sensor data encryption key, and to encrypt the sensor data using the sensor data encryption key.

20. The sensor of claim 19, wherein the logic circuitry is configured to encrypt the sensor data by:
bit-shifting the sensor data by a number of bits that is based upon a byte value of a predetermined byte position within the sensor data encryption key; and
performing an exclusive OR (XOR) operation on (i) the bit-shifted sensor data, and (ii) a portion of the sensor data encryption key having a number of bits equal to the bit-shifted sensor data.

21. The sensor of claim 18, wherein the processing circuitry is configured to decrypt the encrypted device seed data using a predetermined encryption algorithm that utilizes a pre-shared key that is shared by the device and the sensor.

22. The sensor of claim 18, wherein the logic circuitry is configured to generate the common seed by combining the sensor seed and the device seed using a predetermined logic function.

23. The sensor of claim 22, wherein the predetermined logic function comprises an exclusive OR (XOR) function.

24. The sensor of claim 18, wherein the processing circuitry is configured to encrypt at least the portion of the sensor data in accordance with a predetermined cryptographic sponge function to generate the encrypted sensor data.

25. The sensor of claim 24, wherein the predetermined cryptographic sponge function is configured to interconnect a set of permutation matrices, with one or more of the set of permutation matrices receiving, as inputs, data representing the encrypted sensor data that was previously generated by the sensor and transmitted to the device.

26. The sensor of claim 18, wherein the processing circuitry is configured to generate a sensor data encryption key in accordance with a predetermined cryptographic sponge function that receives, as inputs, the common seed and a pre-shared key that is shared by the device and the sensor.

27. The sensor of claim 26, wherein the processing circuitry is configured to generate the encrypted sensor data by encrypting, as the at least the portion of the sensor data, a cyclic redundancy check (CRC) value using the sensor data encryption key.

28. The sensor of claim 27, wherein the communication circuitry is configured to transmit a remainder of the sensor data other than the CRC value to the device as plaintext sensor data.

29. The sensor of claim 28, wherein the communication circuitry is configured to transmit the plaintext sensor data and the encrypted sensor data to the device in accordance with an authentication only scheme.
